(19) United States
(12) Patent Application Publication
(10) Pub. No.: US 2025/0367501 A1
(43) Pub. Date: Dec. 4, 2025

(54) ENHANCEMENTS TO AN EXERCISE BICYCLE

(71) Applicant: Peloton Interactive, Inc., New York, NY (US)

(72) Inventors: Daniel CHAN, Woodinville, WA (US); David HERMILLER, Escondido, CA (US); Jacob BOUCHARD, Brooklyn, NY (US); Julio LIRIANO, Bronx, NY (US); Patrick Fink, Brooklyn, NY (US); Richard JAKUBOWSKI, Staatsburg, NY (US); Kelly JOHNSON, Escondido, CA (US); Thomas WILLIAMSON, Bellevue, WA (US); Sul Gi MYOUNG, New York, NY (US); Shiheng WANG, Jersey City, NJ (US); Kyle MONTGOMERY, Seattle, WA (US); DEE POND, Bothell, WA (US)

(21) Appl. No.: 19/225,902

(22) Filed: Jun. 2, 2025

Related U.S. Application Data
(60) Provisional application No. 63/654,345, filed on May 31, 2024.

(51) Int. Cl. A63B 22/06; A63B 21/00; A63B 21/015; A63B 21/22; A63B 24/00; G01J 5/00

(52) U.S. Cl. CPC A63B 22/0605; A63B 21/00069; A63B 21/00192; A63B 21/015; A63B 21/225; A63B 24/0087; G01J 5/0022; G01J 2005/0033

(57) ABSTRACT

An exercise bicycle having various enhanced or updated features or components is described. For example, the exercise bicycle may include various enhanced brake or braking structures, such as brake locks and brakes having thermal sensing components. The brake, or resistance mechanism, may perform thermal sensing (e.g., measuring a temperature at or around the brake) when the bicycle in being used during an exercise activity, and adjust or modify certain captured parameters (e.g., a resistance applied to a flywheel of the brake and/or a performance output or power level) based on the measured temperature.

### CROSS-REFERENCE TO RELATED APPLICATIONS

This application claims priority to U.S. Provisional Patent Application No. 63/654,345, filed on May 31, 2024, entitled ENHANCEMENTS TO AN EXERCISE BICYCLE, which is hereby incorporated by reference in its entirety.

### BACKGROUND

Exercise bicycles are ubiquitous and ever-changing. For example, a gym, fitness center, hotel, or recreation center may have many users that ride an exercise bicycle throughout a day or week. Similarly, various family members or residents of a house may use an exercise bicycle for their workouts. Thus, an exercise bicycle may be designed, manufactured, and/or configured to accommodate different users, activity environments, and/or use cases.

### BRIEF DESCRIPTION OF THE DRAWINGS

Embodiments of the present technology will be described and explained through the use of the accompanying drawings.

FIG. 1 is a diagram illustrating a suitable exercise bicycle.

FIG. 2 is a diagram illustrating a frame structure for an exercise bicycle.

FIGS. 3A-3C are diagrams illustrating brake structures for an exercise bicycle.

FIG. 4 is a flow diagram illustrating a method for determine a power output for a user performing an exercise activity on an exercise bicycle.

FIG. 5 is a diagram illustrating a brake lock structure for an exercise bicycle.

FIGS. 6A-6D are diagrams illustrating an accessory for an exercise bicycle.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

An exercise bicycle having various enhanced or updated features or components is described. For example, the exercise bicycle may include various enhanced brake or braking structures, such as brake locks and brakes having thermal sensing components. The brake, or resistance mechanism, may perform thermal or temperature sensing (e.g., measuring a temperature at or around the brake) when the bicycle in being used during an exercise activity, and adjust or modify certain captured or measured parameters (e.g., a resistance applied to a flywheel of the brake and/or a determined output/power) based on the measured temperature.

In another example, the exercise bicycle may include a new or enhanced frame structure, such as a monocoque structure, which enables a cost-effective and strengthened frame for the exercise bicycle. Also, the exercise bicycle may include enhanced accessories, such as integrated holders (e.g., bottle and phone holders), which provide users dual-purpose accessories in an efficient and simple manner.

Various embodiments of the apparatuses, components, and/or devices will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of an Exercise Bicycle

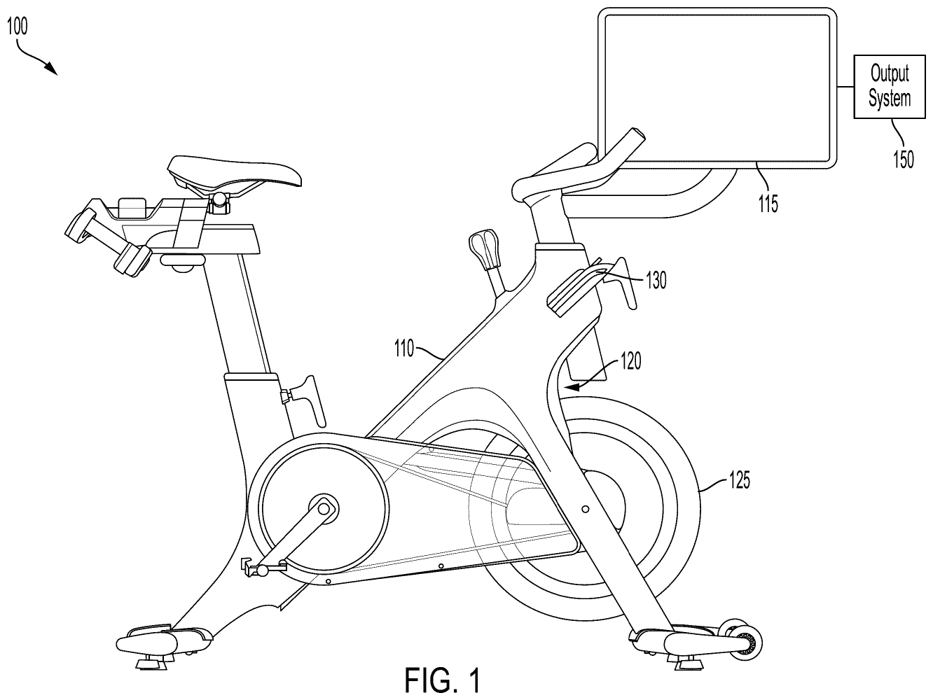

The technology described herein is directed, in some embodiments, to various features of an exercise bicycle. FIG. 1 is a diagram illustrating a suitable exercise bicycle 100. The exercise bicycle 100, or stationary bike, may include a frame 110 that supports a display 115 configured to display or stream content to a user (e.g., rider) of the exercise bicycle 100. The frame 110 may support various frame components, such as a handlebar post that supports handlebars 110, a seat post 112 to supports a seat 114, a rear support 116 and a front support 118. The frame 1100 may also support pedals that, when rotated by a user, may drive a flywheel 125 (or other rotating disc) via a belt, chain, or other drive mechanism.

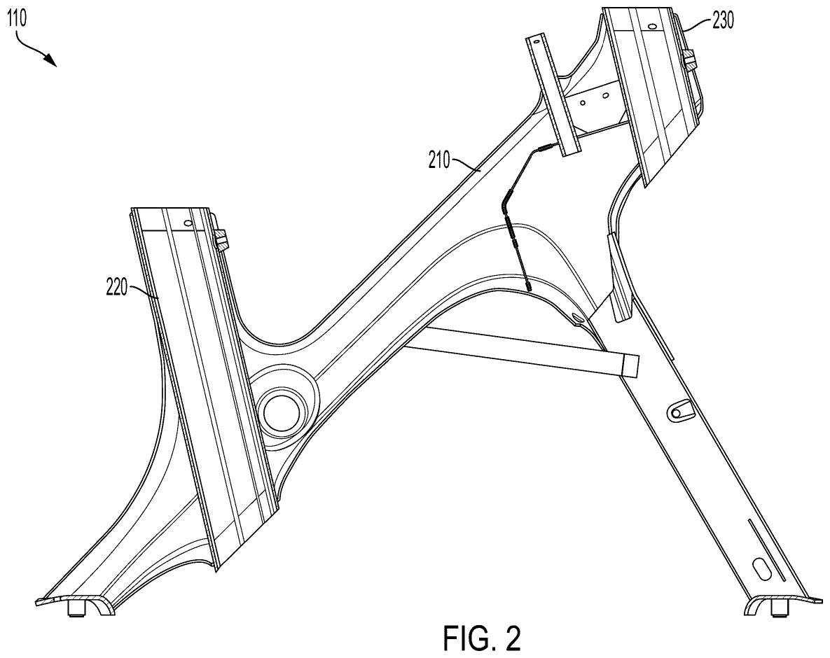

In some examples, the frame 110 may be or be configured as a monocoque structure. FIG. 2 is a diagram illustrating a monocoque structure 200 for the exercise bicycle 100. The monocoque structure 200 includes an outer structure 210 (e.g., a clamshell structure) and two tubes (e.g., a head tube 230 and seat tube 220). The outer structure 210, therefore, acts as a structural skin for the exercise bicycle 100. Thus, the frame 110, in some examples, does not include inner tubes, and instead supports all loads (e.g., a rider on a seat) applied to the frame using the outer structure 210 (e.g., the clamshell structure).

The display 115 may include or support a connected fitness system, which presents information to a user (e.g., a streaming exercise class, workout parameters, and so on). The display 115 may also facilitate communications with other devices, such as remote or local servers, user devices (e.g., mobile devices, smart watches, heart rate monitors, and so on), content servers, and so on. Thus, the exercise bicycle 100 may be integrated and/or communicatively coupled with a connected fitness platform via the display 115 or other communication components of the exercise bicycle 100.

The exercise bicycle 100 also includes a resistance mechanism, brake, or braking device 120. The resistance mechanism, brake, or braking device 120 is configured to apply a resistive force to a flywheel 125 (e.g., a heavy metal disc), which is driven by the user when the user pedals the exercise bicycle 100. A resistance knob, coupled to the brake 120, may directly (e.g., manually) or indirectly (e.g., electronically) control the brake 120 to increase or decrease the resistance of the flywheel 125 to rotation. In some examples, the resistance mechanism, brake, or braking device 120 (or other devices) may include components (e.g., sensors) that measure a temperate at, within, and/or surrounding the flywheel 125 during the rotation of the flywheel 125.

Rotating the resistance adjustment knob clockwise may cause a set of magnets of the brake 120 to move relative to the flywheel, increasing its resistance to rotation and increasing the force that the user applies to the pedals to make the flywheel spin. As another example, the exercise bicycle 100 may include an auto-follow functionality, where streamed content is associated with certain resistance levels or cues, and the brake 120 automatically adjusts the resistance of the flywheel 125 based on the resistance levels or cues within content being viewed by the user.

In various examples, the resistance mechanism, brake, or braking device 120 may be operable to control the level of resistance using electronic systems and mechanisms. Further, it may be desirable to physically measure the amount of torque being applied to the flywheel 125, and the amount of resistance being felt by the user in order to determine how much instantaneous power is being generated and how much total work has been done by the user. Physically measuring the level of applied resistance increases the accuracy of the measurement compared to conventional methods that infer an amount of resistance applied by measuring the position of the braking mechanism relative to the flywheel and comparing this measurement to a previously measured and correlated resistance level.

The resistance mechanism, brake, or braking device 120, in some configurations, may include an electrically driven actuator that drives a resistance brake assembly to pivot (or move) towards and away from the flywheel 125 about a pivot point The pivot point may include one or more screws, bolts, or other components to pivotably attach the resistance brake assembly to the frame 110.

The resistance mechanism, brake, or braking device 120 may include two or more magnets selected and arranged such that, as the magnets move closer to (e.g., eclipsing the edge of the flywheel 125) and/or further away from the center of the flywheel 125, the amount of resistance can be adjusted from a maximum level to zero and vice versa. The flywheel 125 may be made of aluminum or other material capable of generating resistive forces while passing through the field of the magnets. In some cases, the actuator is a stepper motor, such as a permanent magnet linear stepper motor, comprising a shaft. The shaft may have a first end pivotably attached to the frame 110, allowing the shaft to pivot as the stepper motor traverses along the shaft. The fixed end may be hinged preventing rotation along its primary axis. The stepper motor body may be pivotably attached at a mounting point, allowing the stepper motor to pivot relative to the assembly during operation. In operation, the stepper motor is operable to translate up and down the threaded shaft, causing the brake assembly to pivot about the pivot point. As a result, the magnets are selectively moved up and down relative to the flywheel 125 to adjust the resistance.

In some cases, a load cell measures the reaction force transmitted from a second part of the pivoting brake assembly (Including a magnet holding bracket and one or more magnets held therein) to the first part mounted to the frame. The load cell may have a metal body and be comprised of bonded metal foil strain gauges, silicon strain gauges, and/or other components. In some cases, the configuration of the magnet holding bracket and the load cell will be such that the force measured by the load cell will be proportional to the load being applied to the flywheel 125. In order to calculate the torque applied to the user, the product of the applied force, and the distance from the center of the flywheel 125 may yield the torque applied to the flywheel. The rotational speed of the flywheel 125 may also be measured using one or more sensors (e.g., using one or more sensors to measure RPMs). The power absorbed by the resistance apparatus may be calculated as a function of shaft torque and speed, for example by using the formula Power (W)=Shaft Torque (N*m)*Speed (RPM)*0.10472. Further details regarding a suitable resistance mechanism, brake, or braking device 120 may be found in U.S. Pat. No. 12,263,368, which is incorporated by reference in its entirety.

In some embodiments, the exercise bicycle 100 includes or may be equipped with various sensors that can measure a range of performance metrics from both the exercise bicycle 100 and the rider, instantaneously and/or over time. For example, the exercise bicycle 100 may include power measurement sensors, such as magnetometers or magnetic field sensors, which provide continuous power measurement during use. Such sensors may be part of the brake 120.

The exercise bicycle 100 may also include a wide range of other sensors to measure speed, pedal cadence, flywheel rotational speed, temperature, and so on. The exercise bicycle 100 may also include sensors to measure rider heart rates, respiration, hydration, and/or other user physical characteristics or metrics. Such sensors may communicate with storage and processing systems on the bicycle and/or at various local or remote servers. Hardware and software within the sensors or in a separate package may be provided to calculate and store a wide range of performance information.

Relevant performance metrics that may be measured or calculated include distance, speed, resistance, power, total work, pedal cadence, heart rate, respiration, hydration, calorie burn, and so on. Where appropriate, such performance metrics can be calculated as current/instantaneous values, maximum, minimum, average, or total over time, or using any other statistical analysis.

In some examples, the exercise bicycle 100, via the display 115 and/or other computing systems or components, may include or support an output system 150, such as a system having modules configured to determine and present information about an exercise activity performed the user via the exercise bicycle 100. The output system 150, as described herein, may utilize sensor data or other captured data (e.g., cadence, resistance, temperature, and so on) to determine an output or power for a user pedaling the exercise bicycle 100. Further details regarding the output system 150 and its components/modules are described herein.

In some embodiments, the exercise bicycle 100 includes accessories, such as integrated holders 130. The integrated holders 130 may be configured and/or include components that facilitate a multi-purpose functionality. For example, the integrated holders 130 may include a shape that facilitates reception and support of a water bottle or other cylindrical containers, as well as inner reception areas or components that facilitate reception and support of a mobile device or other electronic device. As depicted, the exercise bicycle 100 may include two holders 130, located on each side of the exercise bicycle 100 (e.g., fixed to a front tube of the exercise bicycle 100).

### Examples of a Brake Structure for an Exercise Bicycle

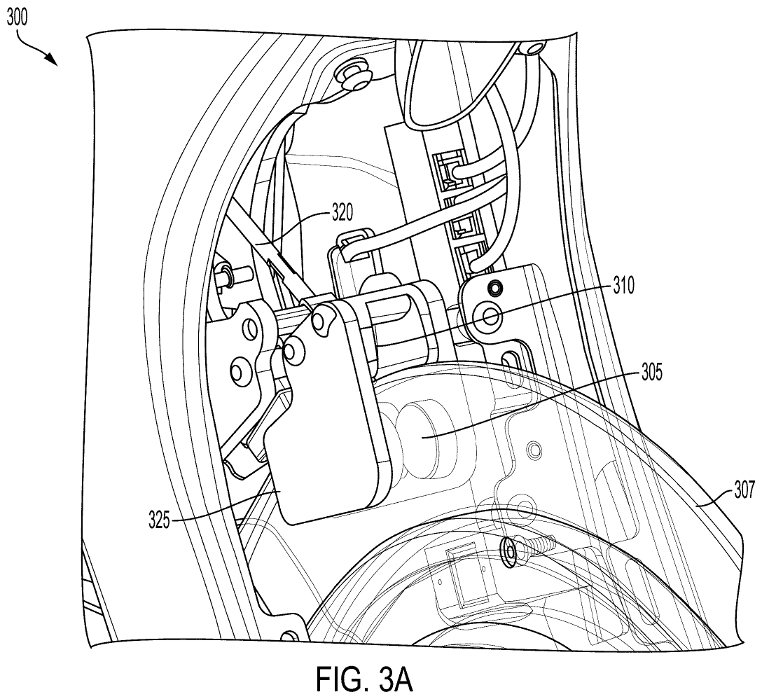

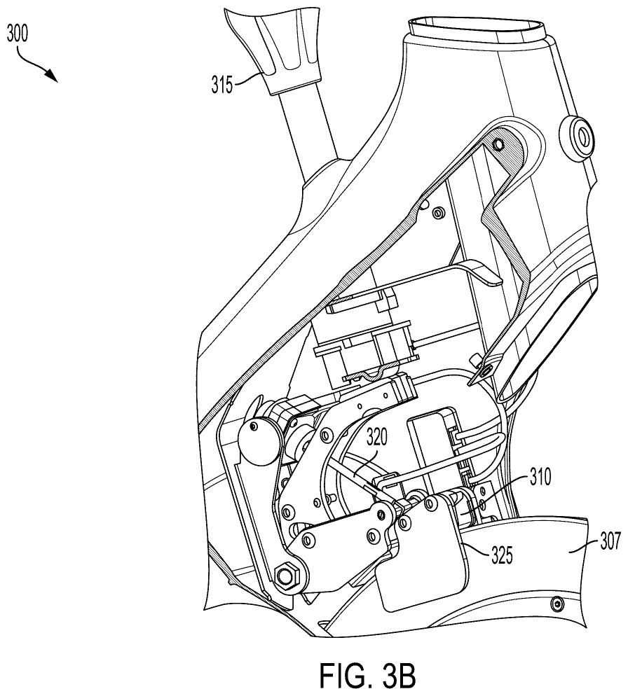

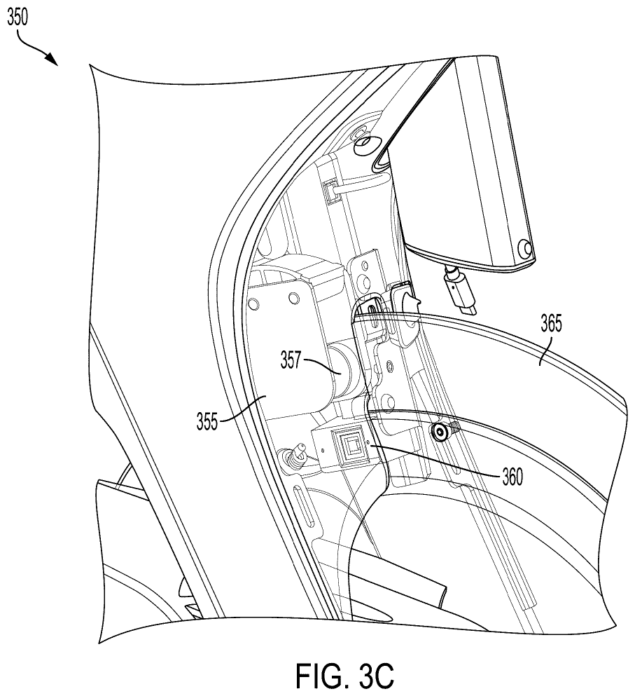

FIGS. 3A-3B are diagrams illustrating a brake structure 300 for the exercise bicycle 100. The brake structure 300, in some embodiments, may be part of the brake 120. The brake structure 300 includes multiple magnets 305 configured to be positioned on either side of a flywheel 307, such as in response to a rotation of a resistance knob 315, coupled to an actuator 320, which positions a brake assembly 325 (e.g., upon which the magnets 305 are mounted or otherwise disposed) closer to (or away from) the flywheel 307.

The brake assembly 325 may also include a thermocouple 310 (or thermal sensor or temperature sensor). The thermocouple 310 may be disposed on the brake assembly 325 and positioned proximate to the flywheel 307 (e.g., slightly above and/or next to the flywheel 307). As described herein, the thermocouple 310 may measure a temperature of the flywheel 307 during operation, which can assist in measuring and adjusting a determined power (e.g., output) as a rider pedals the exercise bicycle 100.

As described herein, the brake structure 300 may be part of a mechanically actuated brake that uses a lead screw attached to the resistance knob 315, which lowers the brake assembly 325 over the flywheel 307. In some cases, the brake may include an encoder to monitor the rotational position of the brake and/or a cadence sensor to monitor flywheel speed (e.g., as a magnet in the flywheel spins past the brake).

FIG. 3C is a diagram illustrating another brake structure 350 for the exercise bicycle 100. The brake structure includes a brake assembly 355 having magnets 357 disposed and/or positioned to apply a resistive force to a flywheel 365. A thermal sensor 360 (or thermocouple or temperature sensor, such as a contactless infrared (IR) temperature sensor) may be part of another component separate from the brake assembly 355.

For example, the thermal sensor 360 may be attached to a housing or support component of the brake structure (e.g., a temperature board) and/or fixed to a front fork component of the bicycle. Thus, the thermal sensor 360 may be positioned proximate to the flywheel 365 at an area or location that is within a center area of the flywheel 365 or otherwise not near the brake assembly 355.

As described herein, the brakes, brake structures, and/or resistance mechanisms described herein may include a thermal sensor (e.g., thermal sensors 310 or 360), which can measure the temperature of the flywheel during use and assist in more accurate power measurements. For example, an electronics board of the exercise bicycle 100 can estimate power input from the rider by sensing the pedaling speed (e.g., cadence), the position of the magnetic brake (e.g., resistance), and the temperature of the flywheel. The electronics board, in some cases, includes an IR sensor configured and/or positioned to point at the flywheel to sense its temperature during operation.

The brake or resistance mechanism, therefore, may include a brake assembly, an actuator that positions the brake assembly with respect to a flywheel of the exercise bicycle, and a temperature sensor that measures a temperature of the flywheel of the exercise bicycle.

Since power is dissipated in the flywheel from the brake (e.g., an eddy current brake), the flywheel heats up during use, and the resistivity of aluminum material in the flywheel increases due to the increasing temperatures, resulting in a diminished generation of eddy currents (with respect to lower temperatures). This increase causes a decrease in the power dissipated by the system with other inputs being constant (e.g., rider pedaling cadence, resistance setting (e.g., magnet brake position)).

The connected fitness system may measure and/or determine activity or performance parameters or metrics via data captured by the sensors. Using the temperature measurements, the system may modify (e.g., reduce) the power calculated and shown to the rider, improving the power reading accuracy shown to the rider and tracked for the rider, among other benefits.

In some cases, the system may utilize the temperature information, as follows. If cadence at a peak crank torque is proportional to a specific resistance of a flywheel, and specific resistance can be approximated by a linear derivation (with respect to a reference temperature, e.g., 20-25 C), the cadence can likewise be approximated by the same reference temperature.

For example, the flywheel (or disc) may have an electrical resistivity p that varies with temperature. The electrical resistivity ρ may be approximated as follows:

$$ρ ( T ) = {ρ}_{0} [ 1 + α ( T - {T}_{0} ) ]$$

Where T₀ represents a reference temperature (e.g., 20° C.), ρ₀ is the resistivity of the flywheel/disk at T₀, and α is a temperature coefficient of resistivity of the disk around T₀.

Given that other parameters of a braking system and/or disk/flywheel (e.g., thickness, magnetic pole diameter, and so on), the critical speed of the disk/flywheel may be as follows:

$${ω}_{k} ( T ) = {ω}_{k 0} [ 1 + α ( T - {T}_{0} ) ]$$

Where T is an observed temperature of the Flywheel, T₀ is the reference temperature, α is the temperature coefficient of resistivity of the Flywheel around T₀ (e.g., constant for all exercise bicycles), and ωₖ₀ is a reference angular velocity or speed.

Thus, the torque at a certain angular velocity and temperature may be determined and/or modeled as follows:

$${τ}_{m} ( ω , T ) = 2 \hat{{τ}_{e}} ω \frac{{ω}_{k} ( T )}{{[ {ω}_{k} ( T ) ]}^{2} + {ω}^{2}} + {τ}_{p 0}$$

Where the coefficients [symbol] , ωₖ₀, and τₚ₀ are all functions of the brake resistance and may be determined based on a power map or other data structure. After testing, the system may generate a lookup table (LUT) that maps the resistance to the different coefficients.

Thus, in one implementation, the system may (1) measure a cadence, resistance, and temperature of a flywheel, (2) determine (e.g., interpolate), based on the measured resistance and the LUT, the coefficients, (3) determine a temperature-compensated critical speed ωₖ, (4) determine a torque (e.g., a crank toque) τₘ based on the cadence, and (5) multiple the crank torque by the cadence to determine a power or output (e.g., dissipated power).

In some cases, the correlation between temperature and power may not be linear (or consistent). For example, during a high power and low cadence movement or activity (e.g., a high or heavy resistance at a low pedaling speed), the heat from the created eddy currents may not be accurately captured by the temperature sensors. Therefore, any adjustments made to a power or output level for a rider may be specific to a cadence level or range during the activity (e.g., an adjustment for a cadence between 0-80 RPMs will be different than an adjustment for a cadence between 80-100 RPMs, and so on).

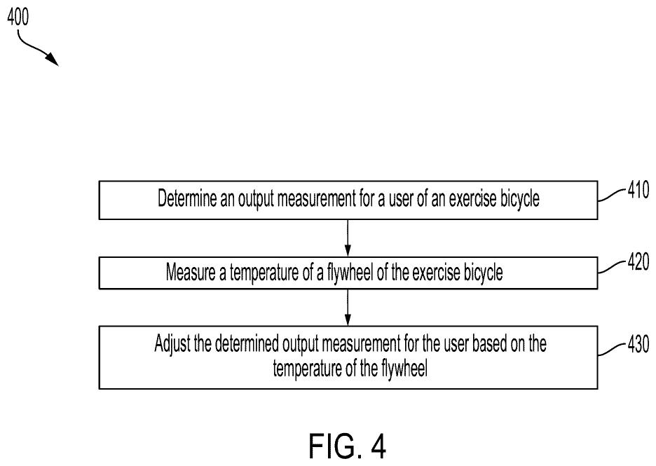

As described herein, the use of temperature data may enable the output system 150 to determine a power or output for a user having an improved or enhanced accuracy, with respect to power/output metrics that do not consider the temperature of a flywheel (e.g., the flywheel 307) during operation. FIG. 4 is a flow diagram illustrating a method 400 for determine a power output for a user performing an exercise activity on an exercise bicycle. The method 400 may be performed by the output system 150 and accordingly, is described herein merely by way of reference thereto. It will be appreciated that the method 400 may be performed on any suitable hardware.

In operation 410, the output system 150 determines an output measurement for a user of an exercise bicycle. For example, the output system 150 may input a cadence measurement along with a resistance measurement into an output or power level formula in order to determine an ongoing, running, and/or overall output or power level for an exercise activity on the exercise bicycle 100.

In operation 420, the output system 150 measures a temperature of a flywheel of the exercise bicycle. For example, the output system 150 may cause the thermal sensor 310 to measure the temperature of the flywheel 307 as it rotates during operation. For example, a temperature sensor that is integrated into a brake assembly (e.g., as depicted in FIGS. 3A-3B or at other positions of the brake assembly 325) of the exercise bicycle may measure or capture the temperature of the flywheel 307. The measurement may be periodic (e.g., every second), continuous, or based on various triggers (e.g., a change in cadence or resistance, an ending of a certain workout segment (e.g., where a total output is determined and presented to a user), and so on.

In operation 430, the output system 150 adjusts the determined output measurement for the user based on the temperature. For example, the output system 150 may adjust (e.g., lower or reduce) an output determination (e.g., coefficients of an output formula, critical speed formula, or other formula) based on the measured temperature, as described herein.

In some cases, the output system 150 may adjust one or more metrics based on the measured temperature (e.g., make an adjustment when determining the output or power level for the user). For example, the output system 150 may adjust the measured resistance or cadence (or coefficients associated with the measured resistance or cadence) based on the measured temperature of the flywheel, and then calculate or otherwise determine the output or power level for the user.

In some embodiments, aspects of the brake structure 300 may be part of an electronically actuated brake that utilizes a load cell in a closed loop setup to apply resistance and/or braking to the flywheel.

In some examples, the brake (e.g., one or more of the brake structures described herein) may automatically lock the flywheel for safety reasons using its motor to lower the armature assembly to the flywheel. This e-brake, or emergency brake, may be decoupled with an actuated brake assembly, and may apply braking without use of the magnets, as described herein.

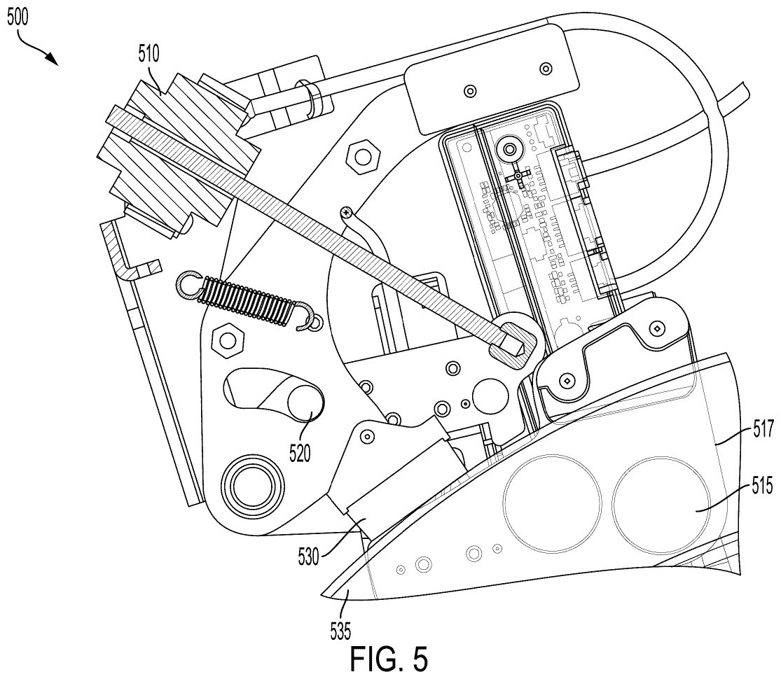

For example, a brake structure can include a brake lock (or bike lock), such as an e-brake or other similar locking structure or mechanism. FIG. 5 is a diagram illustrating a brake lock structure 500 for an exercise bicycle. The brake lock structure 500 may be a software (e.g., electronic) brake lock and/or mechanical brake lock, as described herein.

A software brake lock (set and released upon receiving input from a rider of the exercise bicycle 100 via the display 115) may drive a stepper motor 510 to over travel to a 100% resistance with respect to a flywheel 535. For example, a brake assembly 517 upon which multiple magnets 515 are disposed may pivot or otherwise move to a location, with respect to the flywheel 535, that is associated with an applied resistance of 100%. At that location, a magnet plate 520 catches an e-brake armature and rotates the armature in a downwards direction. An e-brake pad 530 compresses against the flywheel 535, applying friction suitable to lock the flywheel 535 and prevent it from rotating. The stepper motor 510 maintains the location locking the flywheel 535 in place until the user unlocks the flywheel 535 via the software brake lock (e.g., input to a display/tablet/device).

For example, the display 115 of the exercise bicycle 100 may include a locking system, which is configured receives input from a user via a touchscreen of the display 115 and cause the e-brake to lock the flywheel 535. The locking system, which may be part of a computing system associated with the display 115, may cause the flywheel 535 to lock based on user input and/or based on various triggers or actions associated with the exercise bicycle 100 (e.g., a user logs in or logs out of a home screen, the user steps or gets onto the exercise bicycle 100, and so on).

As another example, the exercise bicycle 100 may include a controller (e.g., storing the locking system) mounted to the frame of the exercise bicycle. The locking system, via the controller, may receive the input from the user via a short range communication (e.g., Bluetooth) with a mobile device associated with the user, and cause the e-brake to lock the flywheel 535.

### Examples of an Accessory for an Exercise Bicycle

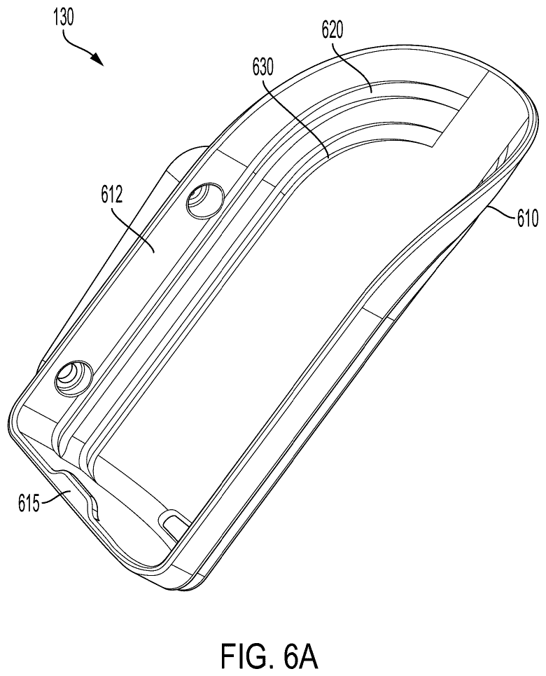

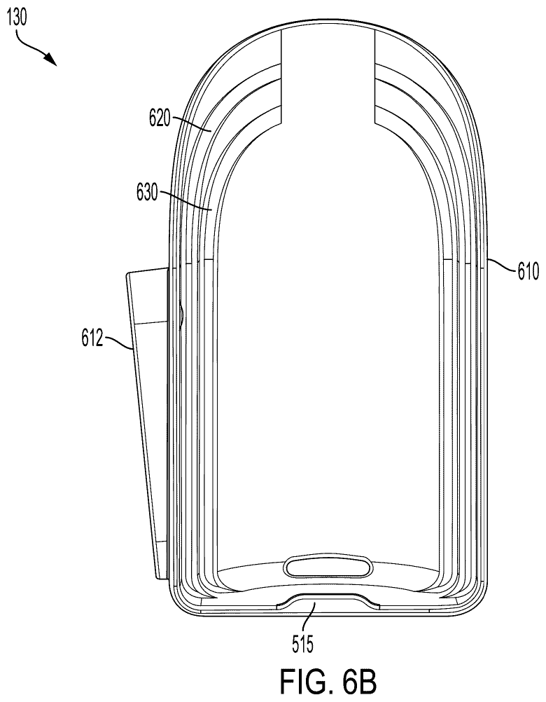

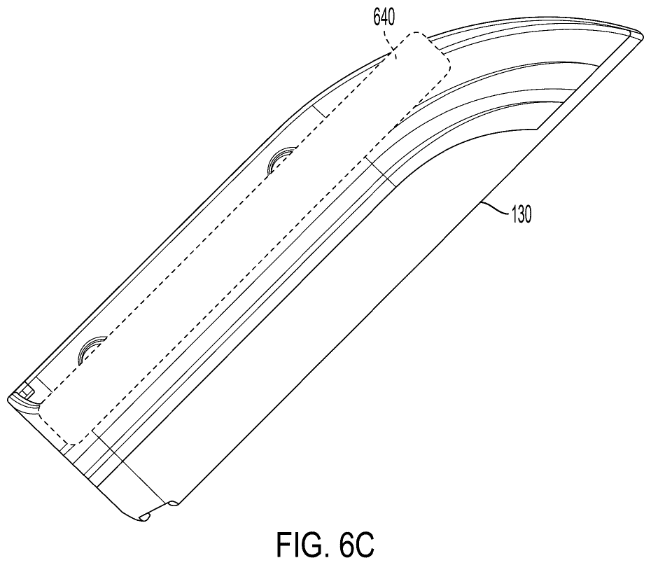

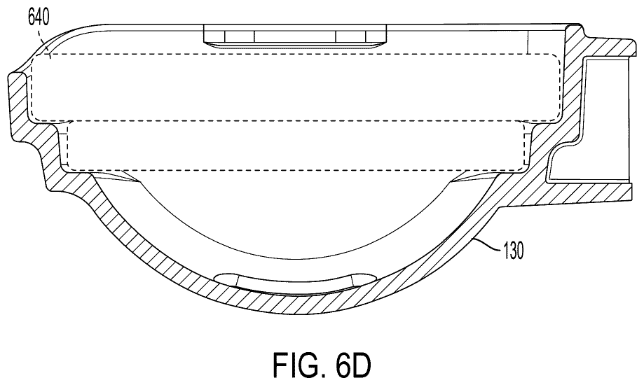

FIGS. 6A-6D are diagrams illustrating the accessory for the exercise bicycle 100. The accessory may be the integrated holders 130. The integrated holders 130 may be configured and/or include components that facilitate a multi-purpose functionality. For example, the integrated holders 130 may include a shape that facilitates reception and support of a water bottle or other cylindrical containers, as well as inner reception areas or components that facilitate reception and support of a mobile device or other electronic device.

For example, each holder includes a housing 610 that has a curved shape configured to receive a water bottle or other bottle, an attachment mechanism 612 that facilitates attachment (e.g., via bolts) of the holder 130 to the frame structure 110 of the exercise bicycle 100, a lip or protrusion 615 that maintains a phone, tablet, or other mobile device 640 to be supported by the holder 130, and one or more inner support compartments or reception areas 620, 630 that are configured to securely hold or support the phone, tablet, or mobile device 640. Thus, each holder can store a water bottle or a mobile device (e.g., a 24 oz, 10.5″ long water bottle and a mobile device of common size and dimensions) in a secure and intended manner.

### Examples of the Disclosed Technology

As described herein, the disclosed technology may be realized as one or more embodiments, examples, or implementations.

In some examples, a brake or resistance mechanism for an exercise bicycle includes a brake assembly, an actuator that positions the brake assembly with respect to a flywheel of the exercise bicycle, and a temperature sensor that measures a temperature of the flywheel of the exercise bicycle.

In some cases, a distance between the brake assembly and the flywheel corresponds to a resistance applied to the flywheel.

In some cases, the brake assembly comprises multiple magnets arranged to apply a magnetic field to the flywheel.

In some cases, the actuator is a mechanical actuator that is coupled to the brake assembly and causes the brake assembly to pivot towards or away from the flywheel.

In some cases, the actuator is an electrically driven actuator that drives the brake assembly towards or away from the flywheel.

In some cases, the brake or resistance mechanism includes an adjustment knob that is coupled to the actuator.

In some cases, the temperature sensor is a contactless infrared (IR) temperature sensor positioned proximate to the flywheel.

In some cases, the temperature sensor is disposed on the brake assembly.

In some cases, the temperature sensor is positioned proximate to the flywheel and disposed on a frame component of the exercise bicycle.

In some cases, the brake or resistance mechanism includes a brake pad that is coupled with the brake assembly and configured to contact the flywheel during a locked state of the exercise bicycle.

In some cases, the brake or resistance mechanism includes a plate coupled to the actuator and an armature coupled to the plate and the brake pad and configured to rotate in a downwards direction and cause the brake pad to contact the flywheel during the locked state.

In some cases, the armature is configured to rotate in an upwards direction and cause the brake pad to release the flywheel during an unlocked state.

In some examples, an exercise bicycle includes a frame, a flywheel supported by the frame, a drive mechanism coupled to the flywheel and configured to drive rotation of the flywheel, a resistance mechanism configured to apply a resistive force to the rotation of the flywheel, and a locking system configured to receive input from a user of the exercise bicycle and cause the resistance mechanism to perform a locking operation using the resistance mechanism and with respect to the flywheel based on the input received from the user.

In some cases, the exercise bicycle includes a display mounted to the frame, wherein the display includes the locking system and receives the input from the user via a touchscreen of the display.

In some cases, the exercise bicycle includes a controller mounted to the frame of the exercise bicycle, wherein the controller includes the locking system and is configured to receive the input from the user via a short range communication with a mobile device associated with the user.

In some cases, the resistance mechanism includes a brake assembly and an actuator that positions the brake assembly with respect to the flywheel of the exercise bicycle.

In some examples, a method includes determining an output measurement for a user of an exercise bicycle, measuring a temperature of a flywheel of the exercise bicycle, and adjusting the determined output measurement for the user based on the temperature of the flywheel.

In some cases, adjusting the determined output measurement for the user includes lowering or reducing the determined output measurement.

In some cases, adjusting the determined output measurement for the user includes adjusting the measured resistance based on the measured temperature of the flywheel.

In some cases, measuring the temperature of the flywheel includes measuring the temperature of the flywheel via a temperature sensor that is integrated into a brake assembly of the exercise bicycle.

In some embodiments, a frame of an exercise bicycle may include a monocoque structure, wherein the monocoque structure includes an outer structure and two tubes.

In some cases, the two tubes include a head tube 230 and a seat tube 220.

In some cases, the outer structure is a clamshell structure.

### CONCLUSION

The exercise bicycle 100 and/or display 115 may provide a computing environment within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable or computer-readable medium having stored thereon instructions which can be used to program a computer (or other electronic devices) to perform a process or method. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The display 115 may include components capable of wirelessly communicating with a network, or cloud, which can be any network, such as a wired or wireless local area network (LAN), a wired or wireless wide area network (WAN), the Internet, some other public or private network, a cellular (e.g., 4G, LTE, 5G, 6G network), and so on. Such connections can be any kind of local, wide area, wired, or wireless network, public or private.

Further, any or all components depicted in the Figures described herein can be supported and/or implemented via one or more computing systems, services (e.g., cloud instances), or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion. \

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments or examples have been described herein for purposes of illustration, but that various modifications may be made without deviating from the spirit and scope of the embodiments. Accordingly, the embodiments or examples are not limited except as by the appended claims.

What is claimed is:

1. A brake for an exercise bicycle, comprising:
a brake assembly;
an actuator that positions the brake assembly with respect to a flywheel of the exercise bicycle; and
a temperature sensor that measures a temperature of the flywheel of the exercise bicycle.

2. The brake of claim 1, wherein a distance between the brake assembly and the flywheel corresponds to a resistance applied to the flywheel.

3. The brake of claim 1, wherein the brake assembly comprises multiple magnets arranged to apply a magnetic field to the flywheel.

4. The brake of claim 1, wherein the actuator is a mechanical actuator that is coupled to the brake assembly and causes the brake assembly to pivot towards or away from the flywheel.

5. The brake of claim 1, wherein the actuator is an electrically driven actuator that drives the brake assembly towards or away from the flywheel.

6. The brake of claim 1, further comprising:
an adjustment knob that is coupled to the actuator.

7. The brake of claim 1, wherein the temperature sensor is a contactless infrared (IR) temperature sensor positioned proximate to the flywheel.

8. The brake of claim 1, wherein the temperature sensor is disposed on the brake assembly.

9. The brake of claim 1, wherein the temperature sensor is positioned proximate to the flywheel and disposed on a frame component of the exercise bicycle.

10. The brake of claim 1, further comprising:
a brake pad that is coupled with the brake assembly and configured to contact the flywheel during a locked state of the exercise bicycle.

11. The brake of claim 10, further comprising:
a plate coupled to the actuator; and
an armature coupled to the plate and the brake pad and configured to rotate in a downwards direction and cause the brake pad to contact the flywheel during the locked state.

12. The brake of claim 10, wherein the armature is configured to rotate in an upwards direction and cause the brake pad to release the flywheel during an unlocked state.

13. An exercise bicycle, comprising:
a frame;
a flywheel supported by the frame;
a drive mechanism coupled to the flywheel and configured to drive rotation of the flywheel;
a resistance mechanism configured to apply a resistive force to the rotation of the flywheel; and
a locking system configured to:
receive input from a user of the exercise bicycle; and
cause the resistance mechanism to perform a locking operation using the resistance mechanism and with respect to the flywheel based on the input received from the user.

14. The exercise bicycle of claim 13, further comprising:
a display mounted to the frame,
wherein the display includes the locking system and receives the input from the user via a touchscreen of the display.

15. The exercise bicycle of claim 13, further comprising:
a controller mounted to the frame of the exercise bicycle,
wherein the controller includes the locking system and is configured to receive the input from the user via a short range communication with a mobile device associated with the user.

16. The exercise bicycle of claim 13, wherein the resistance mechanism includes:
a brake assembly; and
an actuator that positions the brake assembly with respect to the flywheel of the exercise bicycle.

17. A method, comprising:
determining an output measurement for a user of an exercise bicycle;
measuring a temperature of a flywheel of the exercise bicycle; and
adjusting the determined output measurement for the user based on the temperature of the flywheel.

18. The method of claim 17, wherein adjusting the determined output measurement for the user includes reducing the determined output measurement based on the temperature of the flywheel.

19. The method of claim 17, wherein adjusting the determined output measurement for the user includes adjusting a measured resistance based on the temperature of the flywheel.

20. The method of claim 17, wherein measuring the temperature of the flywheel includes measuring the temperature of the flywheel via a temperature sensor that is integrated into a brake assembly or a frame component of the exercise bicycle.
